(19) United States
(12) Patent Application Publication
(10) Pub. No.: US 2009/0191059 A1
(43) Pub. Date: Jul. 30, 2009

(54) WIND POWER PLANT BUKTUKOV-3

(76) Inventors: NIKOLAY BUKTUKOV, Almaty (KZ); Beisen Buktukov, Almaty (KZ); Gulnaz Moldasaeva, Almaty (KZ); Aitmukhamed Zhakyp, Alamty (KZ)

Correspondence Address: John Alumit, 16830 Ventura Blvd. Suite 360, Encino, CA, 91436, US

(21) Appl. No.: 12/353,920

(22) Filed: Jan. 14, 2009

(30) Foreign Application Priority Data
Jul. 14, 2006 (KZ) 2006/0829.1
Sep. 2, 2006 (KZ) PCT/KZ2006/000010

(51) Int. Cl. F03D 3/06

(52) U.S. Cl. 416/131

(57) ABSTRACT

A wind power plant comprising blades connected by a rods, which are fastened, to cantilevers set on a fixed axis with bearings. Each blade is connected to adjacent blades with a stem. The stem is connected to the blade at one end, the other end is connected to the rod of the adjacent blade. The rod of one blade is attached with weights. In different variations of the wind power plant the blades are fastened to the cantilevers, the internal and external edges of each blade at the butt ends are interconnected by a stem, wherein one end of the stem is connected to the rod near the external edge, while the other end is connected to the adjacent blade between the rod center and the internal edge thereof or to the adjacent blade between the center and the internal edge.

### CROSS-REFERENCE TO RELATED APPLICATION

This application claims the benefit of the priority filing date of international application no. PCT/KZ2006/000009, and Kazakhstan application no. 2006/0829.1 filed on Jul. 14, 2006.

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention generally pertains to the power industry, and particularly to the wind power industry, utilized as an independent power supply for facilities, as well as for electric power generation for power systems.

Several wind rotor power plants are known to exist in the art. For example PK patent No. 5595 to Boni-ShKhV discloses wind rotor modules including a guide apparatus and vertical wind rotor blades that have a circular shape. The number of blades and there diameter change with the height in accordance with the Helman formula. The generator group comprises one or more tiers connected to the wind rotor shaft.

RK patent No. 3230 to Savonius discloses a wind turbine system comprising two semi-cylindrical blades located between plates and have inner and outer edges rigidly connected to the shaft kinematically, as well as to the blades by means of a ball socket joint, wherein the blades have weights at their outer edges.

Considerably high costs and inoperability at low wind speeds are common for wind rotor power plants, due to high metal content and the need for high precision manufacturing for power plant operation at high wind speeds. Additionally, in order to increase power with systems known in the art, it is necessary to increase the diameter to more than 0.5 m and to turn the blade edges toward the wind. In doing so, the semi-cylinders uncontrollably shift under wind pressure and are hit by the brackets. This complicates design and reduces the device's reliability. Reducing the semi-cylinders' diameter results in reduced power and a narrower wind speed operating range.

It is therefore, an object of the present invention to provide a wind power plant (WPP) that: increases the use time rate (wind speed operating range expansion), ensures a steady flow of power for the power plant regardless of wind speed and direction, is simplified in design, and increases operational reliability while substantially increasing the power plant's power, resulting in generally lower costs and particularly including operating costs.

### SUMMARY

The present invention comprises (an improved) wind power plant, wherein the achieved technical results comprise weights, brackets, and blades (wind pickups) having inner and outer edges. In a preferred embodiment, the blades are made in the form of two or more semi-cylinder segments of a hollow cylinder. Each blade face comprises inner and outer edges connected along the chord by means of a link. Each link is hinge-attached to brackets between the center and the outer edge wherein the brackets are attached to bearings installed on a stationary axle. At the face of each blade, between the center and the outer edge, each blade is hinge-connected, by means of a rod, to the link of the adjacent blade. One rod end is connected to the blade at its face between the center and the outer edge. The other rod end is hinge-connected to the link of the adjacent blade between the center and the outer edge of the blade. The link of, one blade is hinge-connected to an L-shaped lever-bracket. A weight is attached to the opposite end of the lever-bracket. The lever-bracket is hinge-attached to a bracket.

Still referring to the preferred embodiment, a drive gear is rigidly attached to the lower bracket, and the stationary axle is located inside the gear. A driven gear having a smaller-diameter is engaged with the drive gear. At the bottom, the driven gear is connected to an electromechanical unit by means of a ball socket and/or a universal shaft. At the bottom, the universal shaft (or the shaft with a ball socket) is connected to an electromechanical unit. At the top, the stationary axle is attached to the ground by means of cables or arc-shaped trusses; in turn, the bottom ends of the trusses are attached to ground and tied to each other and/or to the ground by means of cables.

In an alternate embodiment, the achieved technical results of the power plant comprise weights, brackets, and blades (wind pickups, wind-swept surface) in the form of two or more pipe segments (a hollow cylinder) with inner and outer edges, wherein the brackets are rigidly attached to bearings installed on a stationary axle. Between the center and the outer edge, two or more blades are hinge-connected to brackets. At their faces, the inner and outer edges of each blade are connected along the chord by means of a link. Each blade link is hinge-attached to the adjacent blade by means of a rod. One end of the rod is hinge-attached to the link at the outer edge while the other end is hinge-attached to the adjacent blade link between the blade's center and blade's inner edge.

Still referring to the alternate embodiment, a drive gear is rigidly attached to the lower bracket and the stationary axle is located inside the gear. A smaller-diameter driven gear is engaged with the drive gear. At the bottom, the driven gear is connected to an electromechanical unit by means of a ball socket and/or a universal shaft. At the bottom, the universal shaft (or the shaft with a ball socket) is connected to an electromechanical unit. At the top, the stationary axle is attached to the ground by means of cables or arc-shaped trusses; in turn, the bottom ends of the trusses are attached to the ground and tied to each other and/or to the ground by means of cables.

The causal relation between the essential features of the invention and the achieved results is that, when these features are used, wind energy use time rate increases, i.e., a WPP will operate in the speed range of 1-3 to 90 m/s. As a result, the number of days the WPP operates increases more than threefold. Hence, electric power output will also increase more than threefold. In addition, it is possible to substantially increase the power unit's capacity. This is achieved by the fact that at low wind speeds the wind-swept surface area increases, and conversely, when wind speed increases, the wind-swept surface area decreases due to the blades closing about the hinge mount to the bracket. In the case of hurricane wind gusts, the weights close the blades due to centrifugal force, and the WPP takes the shape of a pipe (a hollow cylinder). Reliable operation is achieved due to the simplicity of the design and to the fact that the axle does not rotate, as well as to the presence of a ball socket attachment to the WPP shaft and/or the universal shaft to the electromechanical unit. Cable attachments for small-power WPPs, and attachment by means of arc-shaped trusses, which in turn are tied by cables to the ground and/or to each other, ensure reliable operation at any wind speed and to gusts. These also ensure a substantial increase of the WPP's unit power.

The technical results are increased use time rates of wind energy, regardless of wind direction and speed, simplified design, improved performance, reduced manufacturing costs and operating expenses, and higher reliability, while increasing the wind power plant's output. This is achieved due to the fact that the power plant has weights, brackets, and blades in the form of two or more pipe segments (a hollow cylinder). The brackets are rigidly attached to the bearings. The bearings are installed on a stationary axle. At their faces, the inner and outer edges of each blade are connected along a chord by means of a link. Between the outer edge and the center, each link is hinge-attached to the brackets. At their faces, between the center and the outer edge, each blade is hinge-connected, by means of a rod, to the link of the adjacent blade. One rod end is hinge-connected to the blade between the center and the outer edge, and the other rod end is hinge-connected to the link of the adjacent blade between the center and the outer edge of the blade. The link of one blade is hinge-connected to an L-shaped lever-bracket. Weights are attached to the opposite end of the lever-bracket. The lever-bracket is hinge-attached to a bracket. A drive gear is rigidly attached to the lower bracket and is engaged, via a smaller-diameter driven gear, with a universal shaft or a shaft with a ball socket. The stationary axle is located inside the drive gear. At the bottom, the universal shaft (or the shaft with a ball socket) is connected to an electromechanical unit.

At the top, the stationary axle is attached to support poles or cables. The bottom ends of the support poles or cables are attached to the ground or the foundation. In the middle, the support poles (or cables) are tied, by means of other cables, to the ground and/or to each other.

In yet another alternate embodiment of the present invention, the power plant comprises weights, brackets, and blades (wind pickups, wind-swept surface), in the form of two or more pipe segments (a hollow cylinder), with inner and outer edges. The brackets are rigidly attached to bearings installed on a stationary axle. Two or more blades are hinge-attached to the brackets between the center and the outer edge. At their faces, the inner and outer edges of each blade are connected to each other along a chord by means of a link. The link of each blade is hinge-attached to the link of the adjacent blade by means of a rod. One end of the rod is hinge-attached to the link between the outer edge and the link's center while the other end is hinge-attached to the link of the adjacent blade between the link's center and the inner edge of the blade.

The link of one blade is hinge-connected to an L-shaped lever-bracket. Weights are attached to the opposite end of the lever-bracket. The lever-bracket is hinge-attached to a bracket. A drive gear is rigidly attached to a lower bracket and is engaged, via a smaller-diameter driven gear, with a universal shaft or a shaft with a ball socket. The stationary axle is located inside the drive gear. At the bottom, the universal shaft (or the shaft with a ball socket) is connected to an electromechanical unit. At the top, the stationary axle is attached to support poles or cables. The bottom ends of the support poles or cables are attached to the ground or the foundation. In the middle, the support poles (or cables) are tied, by means of other cables, to the ground and/or to each other.

### BRIEF DESCRIPTION OF THE FIGURES

FIG. 1a is a side cut-away view of a wind power plant.

FIG. 1b is a top view of a wind power plant.

FIG. 2 is a top cross-section view of a four-bladed wind pickup variation of the wind power plant.

FIG. 3 is a cross-section view of another four-bladed wind pickup variation of the wind power plant.

FIG. 4 is a cross-section view of a three-bladed wind pickup variation of the wind power plant.

FIG. 5 is a cross-section view of a three-bladed wind pickup variation of the wind power plant.

FIG. 6 is a cross-section view of another three-bladed wind pickup variation.

FIG. 7a is a side view of the wind power plant.

FIG. 7b is a side sectional cut-away view of the wind power plant.

FIG. 7c is a top view of the wind power plant section referenced in FIG. 7b.

### DETAILED DESCRIPTION

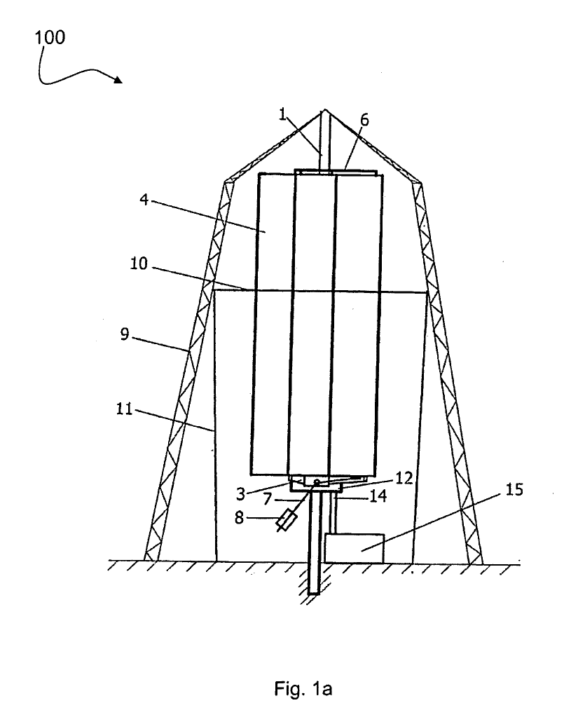

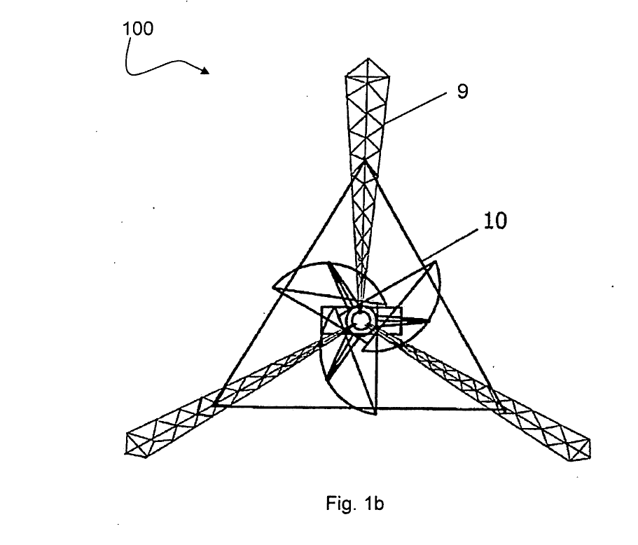

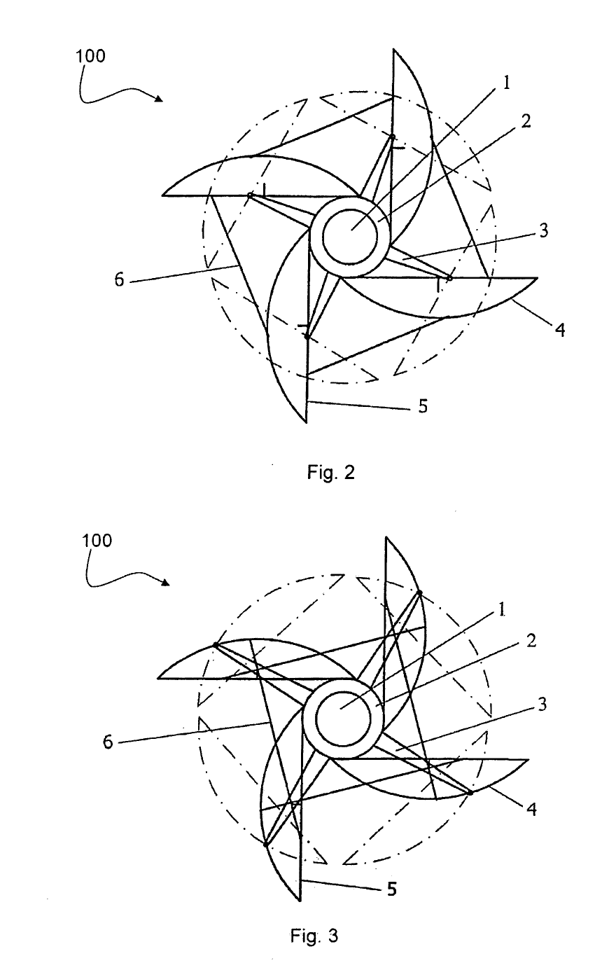

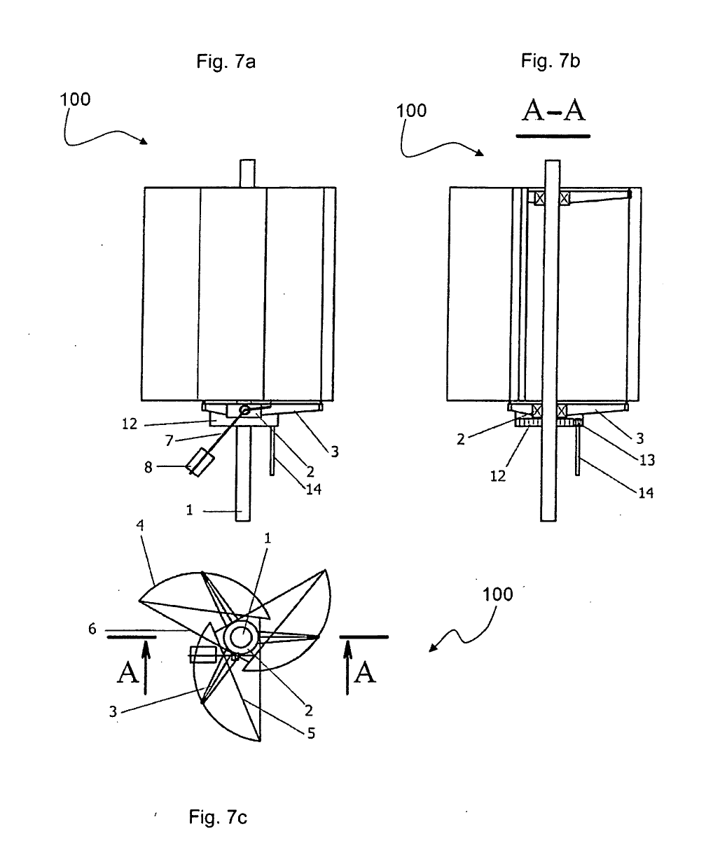

Referring to FIG. 1a a wind power plant (WPP) is shown. The wind power plant 100 comprises a stationary axle 1 and bearings 2 (shown in FIG. 2) wherein Brackets 3 are attached to the bearings. In the preferred embodiment, a link is hinge-attached to the bracket 3 between the outer edge and the center (shown in FIG. 2 and FIG. 6). The link connects the inner and outer edges of the blade 4 at their faces. The Blades 4 are made in the form of a pipe (hollow cylinder) segment. One end of a rod 6 is hinge-attached to the link between the outer edge of the blade 4 and the center of the link 3. The other end of the rod is hinge-attached to an adjacent blade 4 at the face (FIG. 2 and FIG. 6). An L-shaped lever-bracket 7 is hinge-attached to the bracket 3 (shown in FIG. 7). The top end of the lever-bracket is hinge-attached to one of the links between the inner edge and the center. Weights 8 are attached to the bottom end of the lever-bracket 7.

Still referring to FIG. 1 of the wind power plant 100, a drive gear 12 is rigidly attached to the lower bracket 3 at the bottom, and the stationary axle 1 is located inside the drive gear 12. The drive gear 12 is engaged with a smaller-diameter driven gear 13 (shown in FIG. 7b). The driven gear is connected to an electromechanical device 15 via a universal shaft or ball socket 14.

Referring to FIG. 1b of the wind power plant 100, a top view shows the upper end of the stationary axle 1 connected to support poles or cables 9, Wherein the support poles or cables 9 are connected to each other by means of horizontal links 10 and tied to the ground or the foundation by means of links 11 (shown in FIG. 1a) wherein the bottom end of the stationary axle 1 is rigidly attached to the ground or foundation.

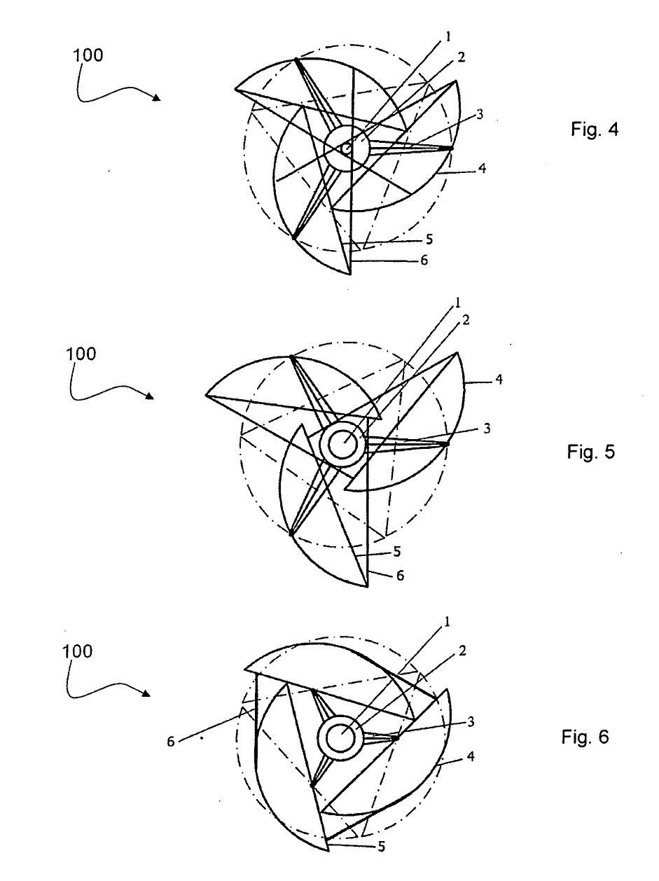

Referring now FIG. 3 of the wind power plant 100, an alternate embodiment is shown comprising a blade 4 hinge-attached at its face, between the center and the outer edge, to the bracket 3. The rod 6 is hinge-attached between the center and the outer edge to a link 5 that connects the outer and inner edges of the blade 4. The other end of the rod 6 is hinge-attached to an adjacent blade 4 between the center and the outer edge. In yet another alternate embodiment, the rod 6 could attach to the outer edge of the blade 4 and to the adjacent blade between the center and the inner edge (as shown in FIG. 4). or conversely attach to the outer edge of the blade 4 and to the link 5 of the adjacent blade between the center and the inner edge (as shown in FIG. 5)

The stationary axle attachment in all embodiments consist of the attachment of a lever-bracket, and the connection to the electromechanical unit resulting in an operational process comprised of wind flow hitting the blades, which cause the blades, brackets and drive gear to turn on the bearings about the stationary axle.

Now referring to FIGS. 7a-7c of the wind power plant 100, the rotation of the drive gear 12 is shown being transmitted by means of the driven gear 13 and the universal shaft (or ball socket) 14 to an electromechanical unit 15 (shown in FIG. 1). When wind speed increases due to centrifugal force, the weights 8 start moving away from the axis of rotation, which results in the lever-bracket 7 diverging about the hinge mount. The lever-bracket 7 pulls the link 5, which results in the blades 4 shifting about the hinge mount. In the case of hurricane wind gusts, the blades 4 close and assume the shape of a cylinder.

In cases when there is no wind available, the weights 8 come down due to gravity, and fully open the blades 4 by means of the lever-bracket 7. The operation of the second embodiment of the wind power plant is similar.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. § 112, paragraph 6. In particular, the use of “step of” in the claims herein is not intended to invoke the provisions of 35 U.S.C. § 112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

The invention claimed is:

1. A wind power plant comprising:
a. weights, brackets, and blades comprising inner and outer edges, wherein the inner and outer edges of the blades at their faces are connected along a chord by means of a link;
b. links attached to the brackets between the center and the outer edge, wherein the brackets are attached to bearings;
c. bearings installed on a stationary axle and each blade at their faces between the center and the outer edge of which is hinge-connected to the adjacent blade by means of a rod, wherein one end of the rod is connected to the blade at their faces between the center and the outer edge, the other end of the rod is hinge-connected to the link of the adjacent blade between the center and the outer edge of the blade;
d. the link of a blade is hinge-connected to an L-shaped lever-bracket and weights are attached to the opposite end of the lever-bracket which is hinge-attached to a bracket;
e. a drive gear rigidly attached to the bracket, wherein the stationary axle is located inside the gear which is engaged with a smaller-diameter driven gear; and
f. a smaller-diameter driven gear connected to an electromechanical unit by means of a ball socket and/or a universal shaft, the stationary axle is attached to the ground or the foundation by means of cables or arc-shaped trusses, and in the middle, the trusses are tied, by means of cables, to the ground and/or to each other.

2. The wind power plant of claim 1, wherein the weights, brackets, and blades with inner and outer edges are distinctive in that two or more blades are hinge-attached at their faces between the center and the outer edge to the brackets.

3. The wind power plant of claim 1, wherein the inner and outer edges of each blade are connected along a chord to each other by means of a link, wherein the link of each blade is hinge-attached to the link of the adjacent blade by means of a rod.

4. The wind power plant of claim 1, wherein one end of the rod is hinge-attached to the link at the outer edge while the second end is hinge-attached to the adjacent blade between the center of the link and the inner edge of the blade or to the adjacent blade between the center and the inner edge.

5. The wind power plant of claim 1, wherein the link of one blade is hinge-connected to an L-shaped lever-bracket.

6. The wind power plant of claim 1, wherein weights are attached to the opposite end of the lever-bracket which is hinge-attached to a bracket and a drive gear is rigidly attached to the bracket.

7. The wind power plant of claim 1, wherein the stationary axle is located inside the drive gear which is engaged with a smaller-diameter driven gear, at the bottom, the smaller-diameter driven gear is connected to an electromechanical unit by means of a ball socket and/or a universal shaft, at the top, the stationary axle is attached to the ground or the foundation by means of cables or arc-shaped trusses, and in the middle, the trusses are tied, by means of cables, to the ground and/or to each other.
